(19) United States
(12) Patent Application Publication
(10) Pub. No.: US 2022/0194289 A1
(43) Pub. Date: Jun. 23, 2022

(54) WEATHERPROOF RAMP DOOR

(71) Applicant: Lippert Components, Inc., Elkhart, IN (US)

(72) Inventors: Frank A. Zappia, III, Mishawaka, IN (US); Josh Black, Osceola, IN (US); Joshua T. Howk, Elkhart, IN (US); Scott C. McKinnon, Union City, MI (US)

(21) Appl. No.: 17/554,733

(22) Filed: Dec. 17, 2021

Related U.S. Application Data
(60) Provisional application No. 63/128,980, filed on Dec. 22, 2020.

(51) Int. Cl. B60P 1/43; B60J 5/10; B32B 5/18; B32B 5/02; B32B 5/24; B32B 7/12; B32B 5/26

(52) U.S. Cl. CPC B60P 1/435; B60J 5/108; B32B 5/18; B32B 5/024; B32B 5/245; B32B 5/022; B32B 2260/046; B32B 5/275; B32B 2605/00; B32B 2266/06; B32B 2307/744; B32B 2262/101; B32B 2260/021; B32B 7/12

(57) ABSTRACT

An RV ramp door is hingedly connected near the vehicle floor for selective opening and closing by a user. A weather-resistant construction of a ramp door includes an inner foam body having an inner face and an outer face, a ramp door inner surface, a ramp door outer surface, a first layer of thermoplastic composite material disposed between the inner face of the foam body and the ramp door inner surface, and a second layer of thermoplastic composite material disposed between the outer face of the foam body and the ramp door outer surface. The ramp door inner surface may be a slip-resistant material, and the ramp door outer surface may be a fiberglass panel. The ramp door may include one or more weep holes for releasing any trapped liquid.

### CROSS-REFERENCES TO RELATED APPLICATIONS

This application claims the benefit of U.S. Provisional Patent Application Ser. No. 63/128,980, filed Dec. 22, 2020, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to ramp doors of recreational vehicles or toy haulers and more particularly to weatherproofing a ramp door to protect it from water retention in extreme weather conditions.

Standard ramp doors that are constructed at least partially of wood can retain water and hold moisture that can remain trapped within the ramp door for nearly its entire lifespan. Water retention within the ramp door can deteriorate the materials at a faster rate and can affect the overall quality and function as well as cause the user to have to replace the door in a shorter period of time than anticipated. The user may have to rush to stow the ramp door in inclement weather or may even be limited to only using the ramp door in times of favorable weather conditions. This may especially cause frustration when the user is using the ramp door to load or unload ATVs, motorcycles, or other sporting equipment or if the user has the ramp door deployed as a patio.

### SUMMARY

It has been long-desired to construct a ramp door to avoid or eliminate water retention after use in inclement weather. In some embodiments, the ramp door of the described embodiments is composed a foam interior encompassed by a polypropylene and fiberglass blended material with a woven material interior surface and a fiberglass exterior surface. The stacking of these materials creates a weatherproof ramp door that is water-resistant and does not retain moisture. The ramp door may also include weep holes for releasing any internal water.

The strength of the ramp door is comparable to existing constructions. The door of the described embodiments is water-resistant and therefore is less likely to deteriorate or be damaged at the same rate as existing constructions.

In an exemplary embodiment, a ramp door hingedly connected to a structure consists of a foam body having an inner face and an outer face, a ramp door inner surface, a ramp door outer surface, a first layer of thermoplastic composite material disposed between the inner face of the foam body and the ramp door inner surface, and a second layer of thermoplastic composite material disposed between the outer face of the foam body and the ramp door outer surface.

The ramp door may be connected to a recreational vehicle. The foam body may be an open celled foam. The ramp door inner surface may be a slip-resistant material, and the ramp door outer surface may be a fiberglass panel. The slip-resistant material may be wherein the slip-resistant material comprises a woven product or laminate material. In some embodiments, the thermoplastic composite material is 50% polypropylene and 50% fiberglass. The ramp door may further include at least one weep hole.

In another exemplary embodiment, a ramp door in a layered construction from an inside surface to an outside surface includes a first layer of thermoplastic composite material, a foam layer body directly connected to the first layer of thermoplastic composite material, and a second layer of thermoplastic composite material directly connected to the foam layer body. The layered construction is without any wood or any product containing wood.

In yet another exemplary embodiment, a method of making a weather-resistant ramp door includes the steps of mounting a first layer of thermoplastic composite material on one of the inner face or the outer face of the inner foam body; mounting a second layer of thermoplastic composite material on the other of the inner face or the outer face of the inner foam body; mounting a slip-resistant material onto the layer of thermoplastic composite material that is mounted to the inner face of the inner foam body, compressing the thermoplastic composite material between the slip-resistant material and the inner foam body; mounting a fiberglass panel onto the layer of thermoplastic composite material that is mounted to the outer face of the inner foam body, compressing the thermoplastic composite material between the fiberglass panel and the inner foam body; and securing a metal extrusion about the periphery of the ramp door.

### BRIEF DESCRIPTION OF THE DRAWINGS

These and other aspects and advantages will be described in detail with reference to the accompanying drawings, in which:

FIG. 1 shows a towed recreational vehicle with an exemplary ramp door;

FIG. 2 is a cross-sectional view of the materials composing a prior art ramp door;

FIG. 3 is a cross-sectional view of the materials composing the ramp door of the described embodiments; and

FIG. 4 is an illustration of an embodiment of the ramp door installed on a vehicle.

### DETAILED DESCRIPTION

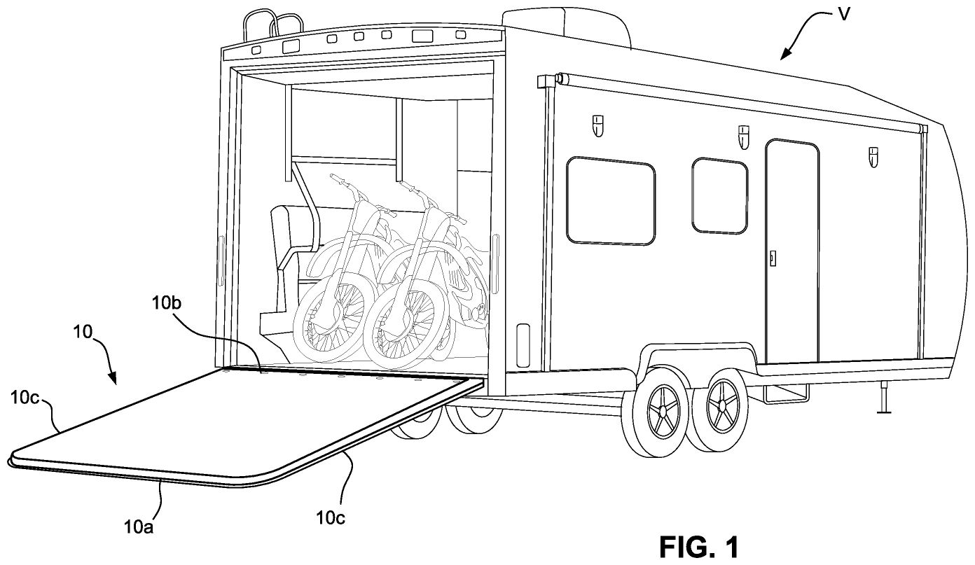

With reference to FIG. 1, an RV ramp door 10 is generally located at the rear of a fifth wheel vehicle or toy hauler trailer V. The ramp door 10 generally has a top 10a, a bottom 10b, and two sides 10c and is hingedly connected approximate to the floor of the vehicle V for selective opening and closing by a user. The periphery of the ramp door 10 may include metal extrusions fitted and secured over the edges of the door. Typically, a ramp door is used either to make contact with the ground for loading or unloading sporting or recreational equipment as shown in FIG. 1, or the ramp door may be suspended by cables to be horizontally flush with the vehicle floor for leisurely use as part of a patio rail kit (not shown).

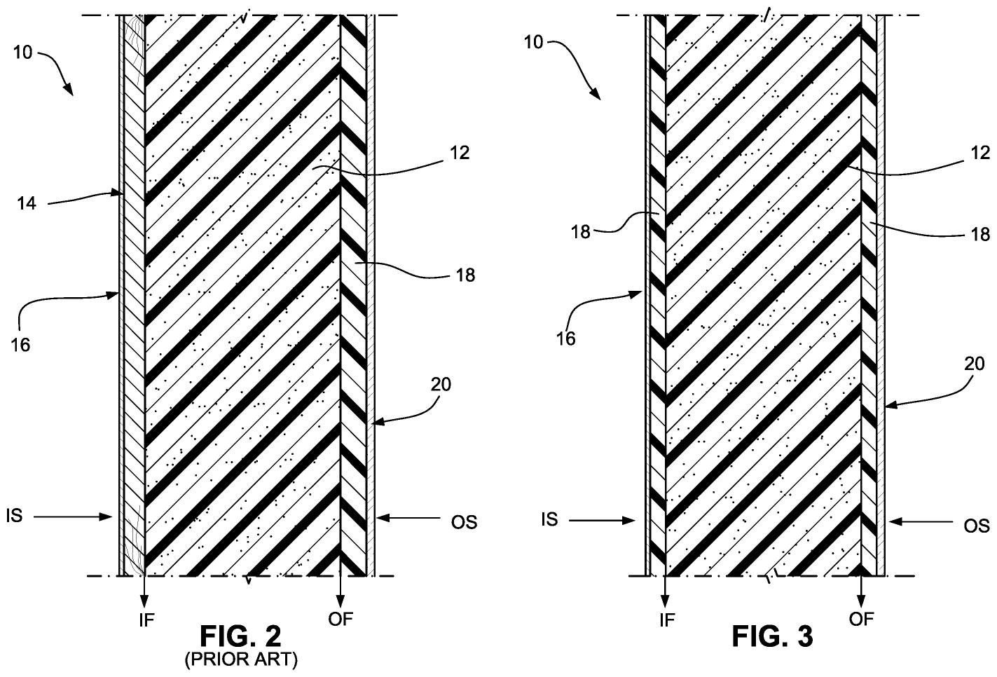

As illustrated in FIG. 2, known constructions of ramp doors may include a foam inner layer body 12 with a layer of wood 14 on the internal face IF compressed by a layer of anti-slip material 16 for the inner ramp door surface IS. The wood layer 14 may vary but typically consists of lauan or plywood. The outer face OF of the ramp door has a layer of thermoplastic composite material 18 compressed by a fiberglass panel 20 for the outer ramp door surface OS.

As illustrated in FIG. 3, the ramp door of the present embodiment includes a foam inner body 12 encompassed on both faces IF, OF by a layer of thermoplastic composite material 18. The inner ramp door surface IS is a layer of slip-resistant material 16 and the outer ramp door surface OS is preferably a fiberglass panel 20. The layers of thermoplastic composite material 18 that encompass the foam layer body 12 are respectively compressed by the inner ramp door surface IS and outer ramp door surface OS to create an overall ramp door that prevents water retention and is mold-resistant. The foam layer body 12 is preferably an open celled foam. The thermoplastic composite material 18 is preferably a non-woven material of 50% polypropylene and 50% fiberglass but could vary in other embodiments. The thermoplastic composite material is suitable to create a durable, lightweight, and water-resistant layer inside of the ramp door to make it weather resistant without adding weight to the door. The anti-slip layer 16 is generally a woven product or laminate material that is slip-resistant for walking on or for tire traction for sporting equipment. The outer surface panel OS could be another fiber-reinforced plastic (FRP) or other durable, water-resistant material.

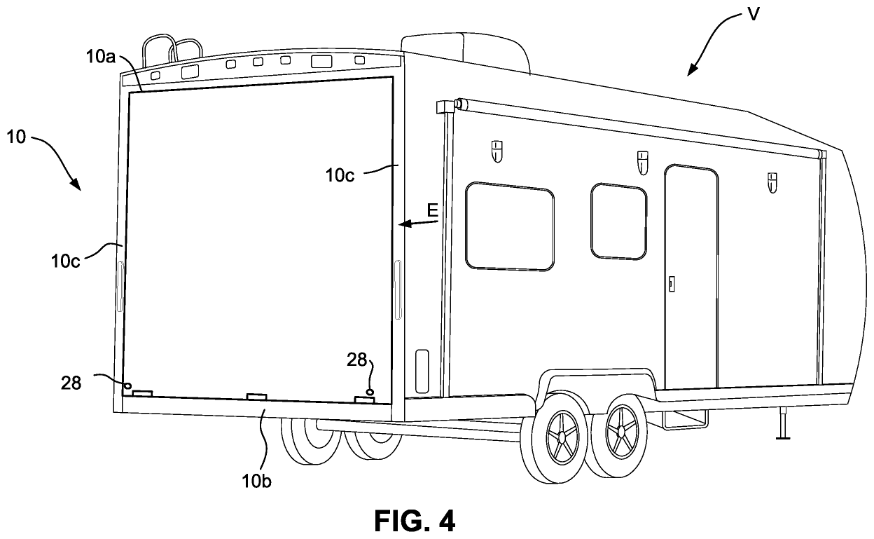

As seen in FIG. 4, the ramp door embodiment described above can be installed on the rear of a vehicle V. The ramp door 10 is preferably constructed with a layer of glue between each layer of material comprising the door, but is also structurally supported by a metal extrusion E that is installed about the periphery of the ramp door that helps to compactly hold the materials in place. The ramp door 10 may also include weep holes 28 to allow drainage of any water or moisture that may enter the ramp door. The weep holes are preferably located near the bottom 10b of the door structure, but can be located anywhere on the door 10. Because all materials of the described embodiment of the ramp door 10 are water-resistant, water is most likely to enter the structure at the extrusions E. Therefore, weep holes 28 may be located near the bottom 10b of the door and adjacent extrusions E located on the sides 10c of the door in some embodiments to release water or moisture. In other embodiments, extrusions E may contain one or more weep holes (not shown) to release trapped water when the ramp door 10 is stowed.

Due to the change in stacking of materials, the ramp door 10 of the described embodiments is completely water-resistant and prevents or precludes retention of water within the structure, therefore protecting the structure from damage and deterioration. The implementation of a second layer of thermoplastic composite material 18 may reduce weight of the ramp door 10. The ramp door may also include weep holes for releasing any internal water.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A ramp door hingedly connected to a structure, the ramp door consisting of:
a foam body having an inner face and an outer face;
a ramp door inner surface;
a ramp door outer surface;
a first layer of thermoplastic composite material disposed between the inner face of the foam body and the ramp door inner surface; and
a second layer of thermoplastic composite material disposed between the outer face of the foam body and the ramp door outer surface.

2. A ramp door according to claim 1, wherein the ramp door is connected to a recreational vehicle.

3. A ramp door according to claim 1, wherein the foam body is an open celled foam.

4. A ramp door according to claim 1, wherein the ramp door inner surface comprises a slip-resistant material.

5. A ramp door according to claim 4, wherein the slip-resistant material comprises a woven product or laminate material.

6. A ramp door according to claim 1, wherein the ramp door outer surface comprises a fiberglass panel.

7. A ramp door according to claim 1, wherein the thermoplastic composite material comprises 50% polypropylene and 50% fiberglass.

8. A ramp door according to claim 1, further comprising at least one weep hole.

9. A ramp door in a layered construction from an inside surface to an outside surface, the ramp door comprising:
a first layer of thermoplastic composite material;
a foam layer body directly connected to the first layer of thermoplastic composite material; and
a second layer of thermoplastic composite material directly connected to the foam layer body,
wherein the layered construction is without any wood or any product containing wood.

10. A ramp door according to claim 9, further comprising a slip-resistant material connected directly to the first layer of thermoplastic composite material, and further comprising a fiberglass panel connected directly to the second layer of thermoplastic composite material.

11. A ramp door according to claim 9, wherein the foam layer body is an open celled foam.

12. A ramp door according to claim 9, wherein the first and second layers of thermoplastic composite material comprise a non-woven material of 50% polypropylene and 50% fiberglass.

13. A ramp door according to claim 9, wherein the foam layer body is connected to the first layer of thermoplastic composite material via a first adhesive layer, and wherein the second layer of thermoplastic composite material is connected to the foam layer body via a second adhesive layer.

14. A ramp door according to claim 13, further comprising a metal extrusion secured around a periphery of the layered construction.

15. A method of making a weather-resistant ramp door, the ramp door including an inner foam body having an inner face and an outer face, the method comprising:
(a) mounting a first layer of thermoplastic composite material on one of the inner face or the outer face of the inner foam body;
(b) mounting a second layer of thermoplastic composite material on the other of the inner face or the outer face of the inner foam body;
(c) mounting a slip-resistant material onto the layer of thermoplastic composite material that is mounted to the inner face of the inner foam body, compressing the thermoplastic composite material between the slip-resistant material and the inner foam body,
(d) mounting a fiberglass panel onto the layer of thermoplastic composite material that is mounted to the outer face of the inner foam body, compressing the thermoplastic composite material between the fiberglass panel and the inner foam body; and
(e) securing a metal extrusion about a periphery of the ramp door.

16. A method according to claim 15, further comprising forming weep holes in the ramp door.

17. A method according to claim 16, wherein the step of forming weep holes in the ramp door comprises forming the weep holes adjacent a bottom of the ramp door and adjacent the metal extrusion.
